(19) United States
(12) Patent Application Publication
(10) Pub. No.: US 2026/0212245 A1
(43) Pub. Date: Jul. 23, 2026

(54) HERMETIC JOINING OF ALUMINA CERAMIC TO TITANIUM AND INCORPORATION INTO AN ION TRAP QUANTUM COMPUTING VACUUM SYSTEM

(71) Applicant: IonQ, Inc., College Park, MD (US)

(72) Inventors: Alexander KATO, Seattle, WA (US); Bjorn FLATT, Los Altos Hills, CA (US); Gershon PERELMAN, Cupertino, CA (US)

(21) Appl. No.: 19/451,673

(22) Filed: Jan. 16, 2026

Related U.S. Application Data
(60) Provisional application No. 63/746,594, filed on Jan. 17, 2025.

(51) Int. Cl. G06N 10/40; F16J 15/00; G21K 1/20

(52) U.S. Cl. CPC G06N 10/40; F16J 15/002; G21K 1/20

(57) ABSTRACT

Aspects of the present disclosure relate generally to systems and methods for use in the implementation and/or operation of quantum information processing (QIP) systems, and more particularly, to hermetic joining of alumina ceramic to titanium and incorporation into a compact ion trap quantum computing vacuum system and/or method for forming ion trap subsystem for a compact room temperature trapped ion quantum computing system.

### CROSS-REFERENCE TO RELATED APPLICATION

This application claims the benefit of U.S. Provisional Patent Application No. 63/746,594, filed Jan. 17, 2025 and hereby incorporates by reference herein the contents of this application.

### BACKGROUND

Aspects of the present disclosure relate generally to systems and methods for use in the implementation, operation, and/or use of quantum information processing (QIP) systems.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of hermetic joining of alumina ceramic to titanium and incorporation into a compact ion trap quantum computing vacuum system and/or method for forming ion trap subsystem for a compact room temperature trapped ion quantum computing system.

In some aspects, a quantum information processing (QIP) system includes a vacuum housing, a ceramic chip carrier, and a frame coupled to the vacuum housing via a first hermetic seal and coupled to the ceramic chip carrier via a second hermetic seal. The first hermetic seal and the second hermetic seal are configured to withstand high temperature bakeout.

In some aspects, a quantum information processing (QIP) system includes a vacuum housing including a titanium material, one or more non-evaporable getters coupled to the housing, a ceramic chip carrier, and a frame coupled to the vacuum housing via a first hermetic seal and coupled to the ceramic chip carrier via a second hermetic seal to define a vacuum chamber therebetween. The vacuum housing, the frame, and the non-evaporable getters are configured to maintain the vacuum chamber at ultra high vacuum (UHV) or extreme high vacuum (XHV) conditions at non-cryogenic temperatures.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions of a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example QIP system including a vacuum housing and a pump in accordance with aspects of this disclosure.

FIG. 5 illustrates a top view of a portion of the QIP system of FIG. 4 with the vacuum housing removed.

FIG. 5A illustrates a section view of the vacuum housing of FIG. 4 taken along lines 5A-5A in accordance with aspects of this disclosure.

FIG. 6 illustrates a section view of the vacuum housing, a ceramic chip carrier, and a frame of the QIP system of FIG. 4 taken along lines 6--6 in accordance with aspects of this disclosure.

FIG. 7 illustrates a bottom view of the frame of the QIP system of FIG. 4 in accordance with aspects of this disclosure.

FIG. 8 illustrates a perspective view of the ceramic chip carrier and the frame of the QIP system of FIG. 4 in accordance with aspects of this disclosure.

FIG. 9 illustrates a perspective view of the ceramic chip carrier and the frame coupled to an ion trap and an interposer of the QIP system of FIG. 4 in accordance with aspects of this disclosure.

FIG. 10 illustrates a side view of the ceramic chip carrier and the frame coupled to the ion trap and the interposer of the QIP system of FIG. 4 in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well known components.

In room-temperature quantum information processing (QIP) systems, an ion trap including a chain of trapped ions is positioned within a vacuum chamber that is maintained under high vacuum (UHV) or extreme high vacuum (XHV) conditions. These UHV or XHV conditions isolate the trapped ions from collisions with other gasses. Such collisions can disturb the trapped ions, reducing the useful lifespan of the chain of trapped ions. As used herein, the term “UHV” refers to pressures between 10⁻⁷ and 10⁻¹² millibar (“mbar”). As used herein, the term “XHV” pressures of 10⁻¹² mbar and lower.

Room-temperature QIP systems typically incorporate a ceramic chip carrier into the vacuum system. In order to incorporate ceramic chip carriers into vacuum systems, there is typically a hermetic seal formed between metallization layers within or on the surface of the ceramic chip carrier and a metal vacuum housing or frame. Typically, the ceramic chip carrier may be coupled to metal surfaces of the frame by then soldering or brazing the metallization layers of the ceramic material to the vacuum housing or frame. The seal between the frame and the chip carrier is subjected to high temperature bakeouts to remove molecules such as water and hydrogen. Further, getters are activated via high temperature bakeouts. Such high temperature bakeouts typically occur at temperatures of at least 250° C., preferably at temperatures of at least 300° C. Therefore, the seal between the ceramic chip carrier and the frame should be able to withstand the heat applied during high temperature bakeout. In systems subjected to high temperature bakeout, brazing is typically used, as soldered connections typically cannot withstand the temperatures of high temperature bakeouts because the melting point of the solder material is less than the temperature used during the high temperature bakeouts.

Typically, a ring frame can be sealed to a first or top side of the ceramic chip carrier, surrounding an ion trap area. In some aspects, components may also be sealed to a second, or back side of the ceramic chip carrier that is opposite the top side of the ceramic chip carrier. The ring frame is typically coupled to the vacuum housing of the QIP system, for example via a mating groove in vacuum enclosure. In some aspects, the ring frame may be coupled to the vacuum enclosure by application of force and heat using an indium seal, or by other methods, such as soldering or mechanical methods. However, indium has a melting point of 150° C., so indium seals cannot withstand high temperature bakeouts. In some aspects, the ring frame may be coupled to the vacuum enclosure in-situ.

The designs and methods used to couple ceramic chip carriers into the vacuum systems of QIP systems that operate at cryogenic temperatures are typically not suitable for coupling ceramic chip carriers into the vacuum systems of room-temperature QIP systems. For example, the seals used in vacuum systems that operate at cryogenic temperatures are typically too gas-permeable for UHV and/or XHV conditions to be maintained at room temperature. Further, for seals that involve the use of mechanical force, the ring frame is pressed into a metal lid of the vacuum housing. Pressing the ring frame and the metal lid together may cause significant stress to be transmitted through the ceramic chip carrier, which can lead to formation of fractures in the ceramic material and lead to leaks that compromise vacuum integrity.

Other methods of sealing the ceramic chip carrier to the vacuum housing may involve conditions that are not suitable for UHV and/or XHV systems. For example, sealing processes may involve background gasses that may contaminate surfaces or saturate getter materials. For example, soldering involves the use of flux, or a pressure of background gas in the rough vacuum range that may lead to contamination (in the case of forming gas or formic acid) or saturation of getters (all cases, also nitrogen and/or hydrogen gas) and gettering surfaces used to achieve UHV and XHV vacuum pressures. Using solder or braze to join the ring frame and the lid of the vacuum housing may be incompatible with forming a vacuum seal in-situ with access to the trap surface for argon ion milling.

In another example, cryogenic temperature vacuum systems may use sealing materials that are not compatible with high temperature bakeouts that are typically used for XHV systems. In such systems, indium can be used to form a seal between the ring frame and the lid or ablation subsystem and chip carrier. However, indium is disadvantageous in a room temperature trapped ion quantum computer because indium has a low melting point that may be below the temperatures used during high temperature bakeout. In another example, some solders, such as leaded solders, may also not be able to withstand the high temperatures used for high temperature bakeout. Such leaded solders having high vapor pressure may be used in die attachment. Sealing materials that involve the use of flux have high gas content, and are prone to outgassing. Since internally-facing vacuum components go through high temperature bakeouts in order to effectively degas these components, seals involving materials that have low melting points can be damaged during high temperature bakeouts.

Further, the material used to manufacture the vacuum enclosure and other components of cryogenic vacuum systems typically generate too many gas molecules via outgassing for UHV and/or XHV conditions to be maintained at room temperature. For example, the getters used in vacuum systems that operate at cryogenic temperatures typically are not effective enough at pumping gas molecules formed by outgassing of system to maintain UHV and/or XHV conditions at room temperature. For example, such getters are typically a charcoal material. It should be appreciated that a room temperature can be between 30 and 80 degrees Fahrenheit, as a non-limiting example.

Further, conventional carrier chips are not configured for backside ablation loading (e.g., loading an ablation system on the back or second side of the carrier chip opposite a front or first side of the carrier chip that is coupled to the ion trap). Backside ablation loading is important for the operation of compact vacuum systems, reducing thermal loads. However, backside ablation loading means that the QIP system has vacuum conditions on both the top and bottom side of the ceramic chip carrier. For example, during ablation loading of ions via the top side of the ceramic chip carrier, unwanted material can be deposited on the surface of the ion trap, which can lead to issues with charging and/or short circuiting of trap electrodes. These issues can be reduced or prevented by using ablation loading from the backside of the ion trap, such that the ablated target material does not have line-of-sight to the surface of the ion trap, thus reducing or preventing the probability of shorting and charging.

Since the ring frame and the ceramic carrier undergo high temperature bakeouts while coupled together, the ring frame material should have a similar coefficient of thermal expansion (CTE) to the CTE of the ceramic material. However, these materials are generally not studied for or selected for their UHV/XHV properties. For example, metals such as tungsten-copper (WCu), or kovar may be selected for CTE matches, none of which have significant data reported on their outgassing properties for use in UHV/XHV. Moreover, any seals formed to these metals must be compatible with the metals. In particular, there are limitations on what materials can be welded together, for example, titanium should only be welded to titanium.

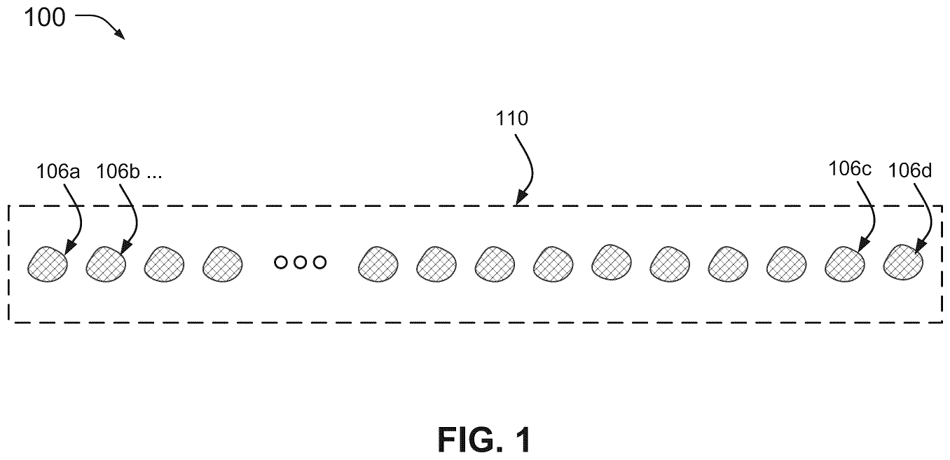

Solutions to the issues described above are explained in more detail in connection with FIGS. 1-10, with FIGS. 1-3 providing a background of QIP systems or quantum computers, and more specifically, of atomic-based QIP systems or quantum computers.

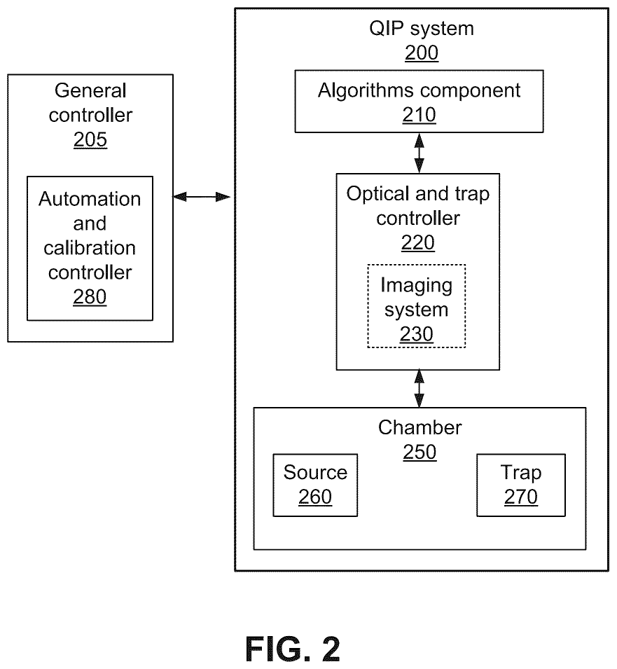

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the trap 270, the chamber 250, and/or the source 260.

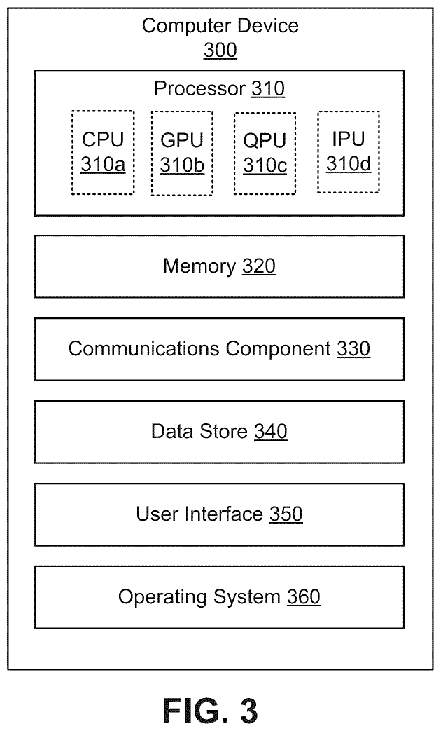

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, the aspects herein provide QIP system in which a frame is hermetically sealed to a vacuum housing and a ceramic chip carrier in a manner that allows the frame, the vacuum housing, the ceramic chip carrier, and the seals therebetween to withstand high temperature bakeout. As used herein, the term “high temperature bakeout” refers to baking components of the QIP system at temperatures of at least 250° C., and preferably temperatures at or above temperatures of 300° C. Further, the frame allows the ceramic chip carrier to be coupled to a vacuum housing in a manner that allows the ion trap to be coupled to a front surface of the ceramic chip carrier and allows other components to be coupled to a back surface of the ceramic chip carrier.

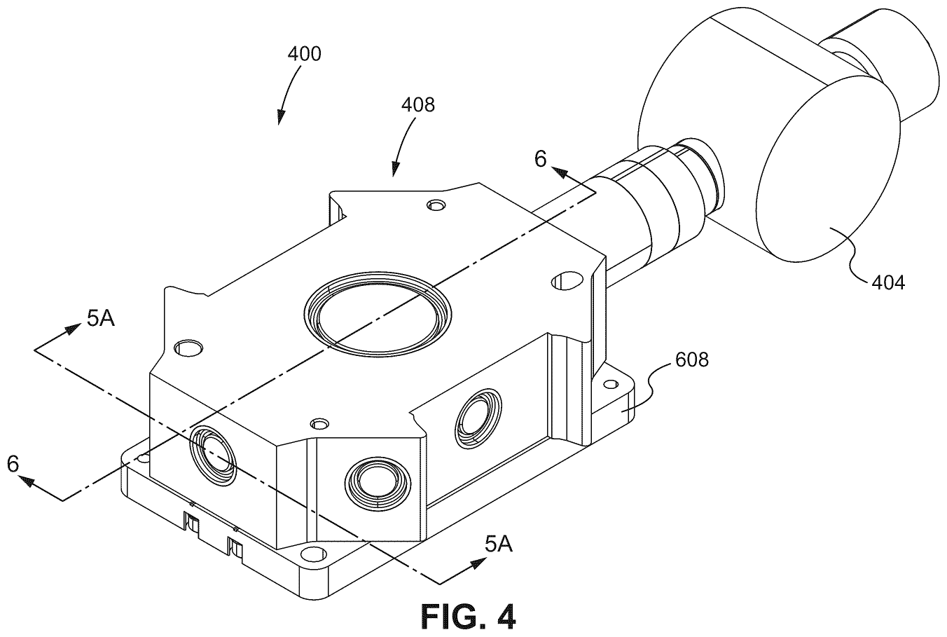

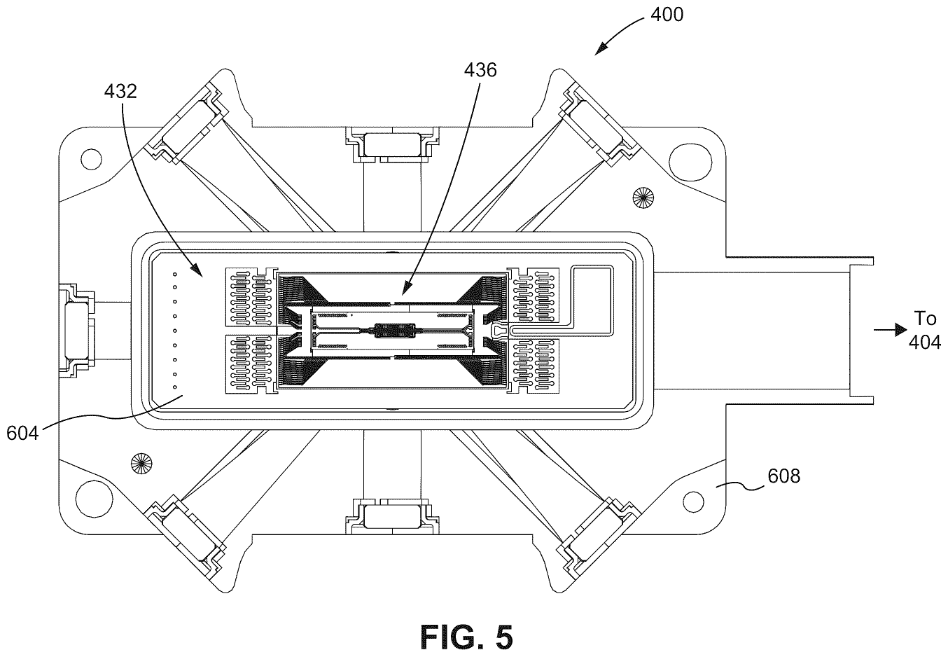

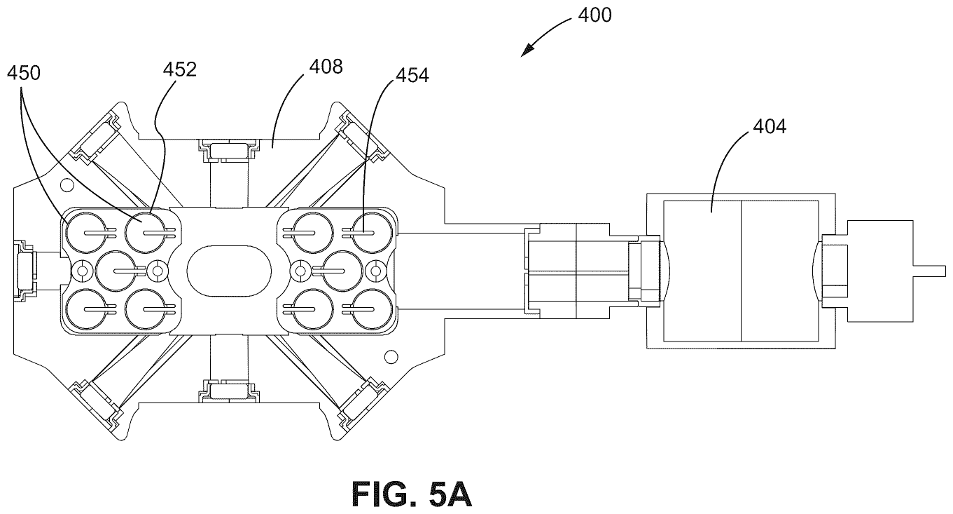

FIG. 4 illustrates an example room-temperature QIP system 400. FIG. 5 illustrates a top section view of a portion of the QIP system 400 with the vacuum housing 408 removed. The QIP system 400 includes an ion pump 404, a vacuum housing 408, and a frame 608. In an example aspect, the QIP system 400 is a compact QIP system. During operation of the QIP system 400, the chamber 432 is maintained under UHV or XHV conditions. In some aspects, the ion pump 404, the getters 450, and/or the titanium walls of the vacuum housing 408 are configured to maintain UHV or XHV conditions at non-cryogenic temperatures. For example, the ion pump 404, the getters 450, and/or the titanium walls of the vacuum housing 408 are configured to maintain UHV or XHV conditions at room temperature. For example, the ion pump 404, the getters 450, and/or the titanium walls of the vacuum housing 408 are configured to maintain UHV or XHV conditions when cooled with liquid nitrogen.

In the example QIP system 400, the vacuum housing 408, a ceramic chip carrier 604 (FIG. 5), and the frame 608 define the vacuum chamber 432 (FIG. 5), which may be similar to (or correspond to) the chamber 250. The vacuum housing 408 includes sidewalls 410 and a top wall 412 As shown in FIG. 5, an ion trap 436, which may be similar to (or correspond to) the ion trap 270, is positioned within the chamber 432. The ion pump 404 may be coupled to the ion trap 436 and is configured to provide ions to the ion trap 436.

The QIP system 400 includes one or more getters 450 configured to pump residual gasses out of the chamber 432. The getters 450 may be or include a titanium material or an alloy such as a Zirconium-Vanadium-Iron (Zr-V-Fe) alloy. As shown in FIG. 5A, in the illustrated aspect, the getters 450 are positioned within openings 414 within the top wall 412 of the vacuum housing 408. The getters 450 may be secured within the openings 414 via clips 416. In other aspects, the getters 450 may be positioned elsewhere, for example in the side walls of the vacuum housing 408.

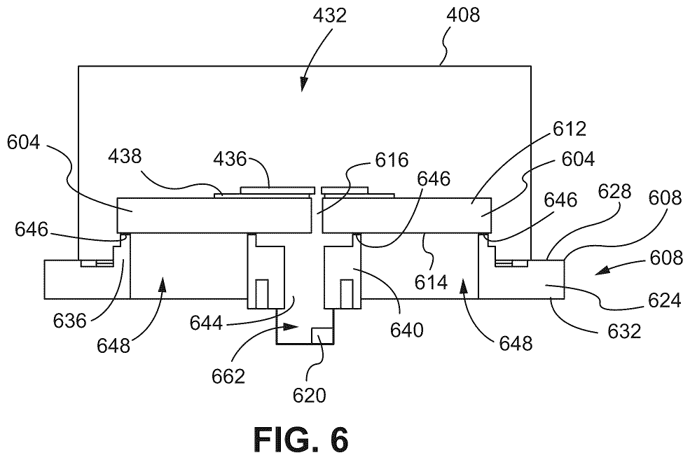

FIG. 6 illustrates a section view of the QIP system 400 according to aspects of the present disclosure. As shown in FIG. 6, the ceramic chip carrier 604 is directly coupled to the frame 608 via a hermetic joint. As shown in FIG. 6, a portion of the ceramic chip carrier 604 forms part of the enclosure between vacuum conditions within the chamber 432 and ambient conditions outside of the vacuum chamber 432. As is discussed in greater detail below, the frame 608 is a metal material such as titanium. Titanium has outstanding vacuum properties, including low outgassing, and in many cases can be used as a vacuum pump. Moreover, titanium is strong and lightweight. Further, in aspects in which the frame 608 includes titanium, the frame 608 and the ceramic chip carrier 604 may be able to undergo high temperature bakeout at a temperature high enough that the frame 608 may be able to function as a getter and add to the total pumping rate of the compact ion trap system. The ceramic chip carrier 604 is a high temperature co-fired ceramic (HTCC) material. In some aspects, the ceramic material of the ceramic chip carrier 604 may be a HTCC material having a high alumina content.

The ceramic chip carrier 604 includes a first or top side 612 and a second or bottom side 614 opposite the top side 612. The top side 612 faces the chamber 432. The ion trap 436 is coupled to the top side 612 of the ceramic chip carrier 604. The frame 608 is directly coupled to the bottom side 614 of the ceramic chip carrier 604. For example, the frame 608 is directly brazed to the ceramic chip carrier 604 to form a hermetic joint between the frame 608 and the ceramic chip carrier 604.

Due to the high temperature of the brazing process, combined with the brittleness of ceramics, it is advantageous to have a good match of coefficient of thermal expansion (CTE) between the metal material of the frame 608 and ceramic material of the ceramic chip carrier 604. Such a CTE match means that the material of the frame 608 and the material of the ceramic chip carrier 604 experience similar amounts of thermal expansion when exposed to high temperatures, such as the temperatures involved in brazing and/or high temperature bakeout, and similar shrinkages during cooling. In other words, in an exemplary aspect, the material of the metal frame 608 and ceramic chip carrier 604 have sufficiently similar thermal expansion over the brazing temperature profile such that the differential thermal strain remains low, keeping induced stresses below the fracture limits of the respective materials. Preferably, the differential thermal strain (e.g., Δε=(αmetal−αceramic)·ΔT) is configured to remain below the levels that would induce damaging stresses (e.g., the fracture limits). In practice, this implies selecting materials whose CTEs are closely aligned (e.g., within a few parts per million per degree Kelvin (e.g., 2 or less ppm/K) across the relevant temperature excursion) so as to minimize residual stress, cracking, or warpage during cool-down and subsequent thermal cycling. Thus, it should be appreciated that similar thermal expansion during heating and cooling therefore results in a more robust seal. Titanium has a close CTE to that of alumina ceramic, which makes titanium a good candidate for a braze joint. A braze joint between the metal material of the frame 608 and the ceramic material of the ceramic chip carrier 604 forms a simple and robust joint design is able to withstand thermal cycling such as, for example, one or more high temperature bakeouts.

Due to the high alumina content of HTCC ceramic material, the HTCC ceramic material has a linear CTE of 7.2 about ppm/K. Titanium, an excellent vacuum material, has a linear CTE of 8.6. Hence, a reasonable CTE match is observed between these materials. In aspects in which the frame 608 includes a titanium material and the ceramic chip carrier 604 includes a HTCC material, the titanium material is directly brazed to the HTCC material directly as a method of incorporating the ceramic chip carrier 604 into the compact QIP system 400. This differs from previous QIP systems that used a titanium vacuum chamber, where another type of metal was first sealed to the chip carrier, and therefore, another seal was also required between the titanium and intermediate metal. Joining titanium to the intermediate metal is also typically difficult because titanium is difficult to weld to non-titanium metals. Therefore another advantage is that fewer materials are required, and less seals are needed, which reduces the likelihood of leaks and/or damage to the ceramic chip carrier 604 during sealing. For example, the seal between the intermediate metal/ring frame and titanium is often difficult, requiring a direct application of force between the two materials. These forces can put excess pressure on the ceramic chip carrier, which can suffer from fractures and leak. Another advantage is that removing the intermediate metal reduces the size of the QIP system 400.

Returning to FIG. 6, in some aspects, the ion trap 436 may be directly coupled to the top side 612 of the ceramic chip carrier 604. In other aspects, the ion trap 436 may be indirectly coupled to the top side 612 of the ceramic chip carrier 604, for example by an interposer 438. A passageway 616 extends through the ceramic chip carrier 604 such that ions can be provided to the ion trap 436 from an ablation loading subsystem shown schematically by box 620 via the bottom side 614 of the ceramic chip carrier 604.

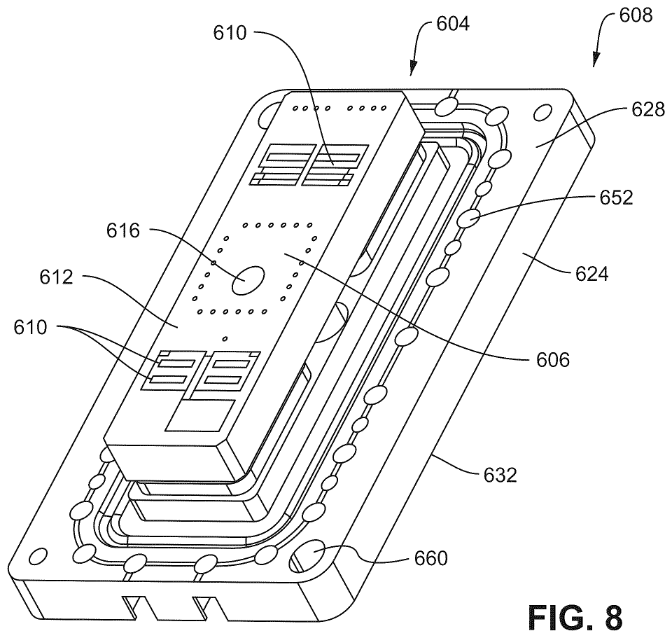

As shown in FIG. 8, the top side 612 of the ceramic chip carrier 604 may include a die attachment area 606 configured to attach the ion trap 436 and/or an interposer 438 to the top side 612 of the ceramic chip carrier 604. In some aspects, the top side 612 of the ceramic chip carrier 604 may include one or more wirebond pads 610.

Returning to FIG. 6, the bottom side 614 of the ceramic chip carrier includes one or more electrical connections 618 to allow electrical access to the wirebond pads 610. In some aspects, the electrical connections 618 may be or include gold pads. In some aspects, the electrical connections 618 may include land grid arrays (LGAs) and/or pin grid arrays (PGAs). The electrical connections 618 allow electrical connections between components within the vacuum chamber 432 via the wirebond pads 610 and components outside of the vacuum chamber 432. Providing such electrical connections 618 on the ceramic chip carrier 604 further facilitates compactness of the QIP system by eliminating unnecessary additional components that would otherwise be needed to couple the components of the vacuum chamber 432, for example.

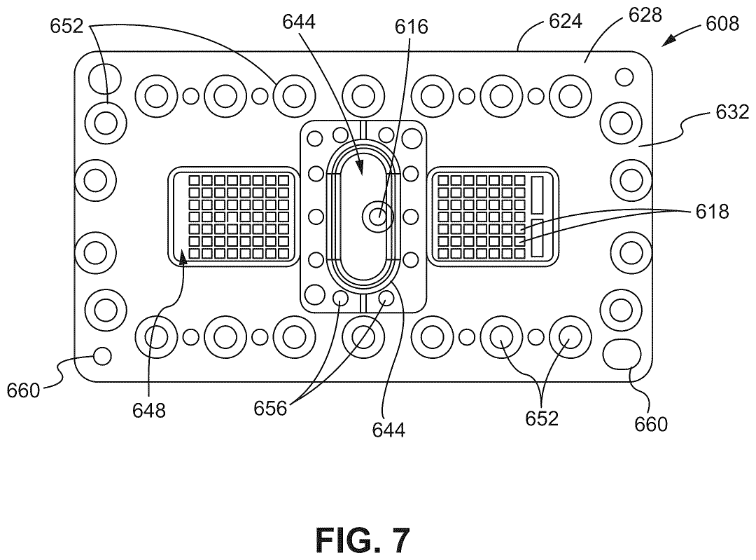

As shown in FIGS. 6-7, the frame 608 includes a substantially planar body 624 having a first surface 628 and a second surface 632 opposite the first surface 628. The first surface 628 of the frame 608 is brazed to the bottom side 614 of the ceramic chip carrier 604 via braze joints 646. Brazing the frame 608 to the bottom side 614 of the ceramic chip carrier 604 allows a second vacuum volume 662 to be formed on at least a portion of the bottom side 614 of the ceramic chip carrier 604. For example, in some aspects, the second vacuum volume 662 can be or include an ablation loading subsystem 620. Thus, the second vacuum volume 662 can reduce the size of the QIP system 400 because conduits do not need to be used to couple the ceramic chip carrier to additional vacuum systems and/or the vacuum chamber 432 does not need to be positioned within a larger vacuum system for ion loading.

The planar body 624 also includes an outer protruding portion 636 and an inner protruding portion 640 extending above the first surface 628 of the planar body 624. The inner protruding portion 640 includes a passageway 644 such that ions can be provided to the ion trap from an ablation source of an ablation loading subsystem 620 via the bottom side 614 of the ceramic chip carrier 604. The outer protruding portion 636 and the inner protruding portion 640 are coupled to the back side 614 of the ceramic chip carrier 604 via braze joints 646. Thus, the ceramic chip carrier 604 is vertically spaced from the vacuum housing 408 when the ceramic chip carrier 604 and the vacuum housing 408 are coupled to the frame 608. The braze joints 646 are configured to form a hermetic seal between the ceramic chip carrier 604 and the frame 608. In some aspects, the braze joints 646 are tee braze joints. In some aspects, the braze joints 646 may have other geometries or configurations.

As shown in FIG. 7, the planar body 624 of the frame 608 may include holes 648 to allow access to electrical connections 618 on the back side 614 of the ceramic chip carrier 604 when the ceramic chip carrier 604 is coupled to the frame 608.

The planar body 624 further includes a first plurality of attachment features 652 positioned around a perimeter of the planar body 624. The first plurality of attachment features 652 are configured for forming a hermetic mechanical compression seal between the frame 608 and the vacuum housing 408. In some aspects, the hermetic compression seal may be formed between a perimeter of the frame 608 and a perimeter of the vacuum housing 408. For example, in the illustrated aspect, the attachment features 652 include a plurality of through holes configured to receive fasteners therein. In other aspects, the attachment features 652 may have another configuration. In operation, the attachment features 652 of the frame 608 are aligned with corresponding attachment features on the vacuum housing 408 and are coupled together by fasteners such as screws or bolts. The seal between the frame 608 and the vacuum housing 408 is formed by tightening and torquing the fasteners to form a vacuum-tight mechanical compression seal. The compression forces of the seal are transmitted between the vacuum housing 408 and the frame 608. Since the ceramic chip carrier 604 is not directly sealed to the vacuum housing 408, the stresses from the compression seal are not transmitted to the ceramic chip carrier 604, which reduces the probability of fracturing or otherwise damaging the ceramic chip carrier 604 and causing leaks. Further, such hermetic mechanical compression seals can be formed in-situ. Such hermetic mechanical compression seals are suitable for UHV and XHV systems. Such hermetic mechanical compression seals can withstand the temperatures used during high temperature bakeouts.

The planar body 624 further includes a second plurality of attachment features 656. In the illustrated configuration, the second plurality of attachment features 656 surrounds the passageway 644. The second plurality of attachment features 656 are configured for forming a hermetic mechanical compression seal between the frame 608 and other system components. For example, in the illustrated aspect, the attachment features 656 include a plurality of through holes configured to receive fasteners therein. In other aspects, the second plurality of attachment features 656 may have another configuration. The seal between the frame 608 and the other system components formed via the attachment features 656 is a hermetic mechanical compression seal that may be similar to the seal between the frame 608 and the vacuum chamber 432 described above. In some aspects, the hermetic mechanical compression seal between the frame 608 and the other system components (e.g., via the attachment features 656) may be demountable, such that the other system component(s) can be removed from the frame 608). Mechanical seals may be baked out at the higher temperatures needed for effective degassing and getter activations required for room temperature XHV.

In some aspects, the second attachment features 656 are configured to form a hermetic mechanical compression seal between the frame 608 and an ablation loading subsystem 620, which allows backside loading of the ion trap 436. In such aspects, a vacuum housing 658 of the ablation loading subsystem 620 can be coupled to the bottom side 614 of the ceramic chip carrier 604 to form a second vacuum chamber 662. The second vacuum chamber 662 may be used for ablation loading of the ion trap 436 via the passageways 616, 644. Backside ablation loading is advantageous because it reduces line of sight from the ablation loading subsystem 602 to the top surface 612 of the ceramic chip carrier 604, which prevents debris from the ablation process from reaching the top surface 612 of the ceramic chip carrier 604 and/or the ion trap 436.

Further, since the seal formed between the frame 608 and the ablation loading subsystem 620 (via the attachment features 656 and corresponding attachment features of the vacuum housing 658) may be demountable, the ablation loading subsystem 620 may be coupled to the frame 608 after other components of the QIP system 400 have been assembled. For example, if the ablation loading subsystem 620 is coupled to the frame 608 after the ceramic chip carrier 604 has been coupled to the frame 608, the ablation loading subsystem 620, including the ablation source, may not be exposed to conditions needed for brazing between the frame 608 and ceramic chip carrier 604. In another example, the ablation loading subsystem 620 may be coupled to the frame 608 after the die attachment has been formed between the ion trap 436, the interposer 438, and the ceramic chip carrier 604. Forming the braze between the frame 608 and the ceramic chip carrier 604 and forming the die attachment between the ion trap 436, the interposer 438, and the ceramic chip carrier 604 can involve elevated temperatures and may include fluxes or background gasses that may compromise the ablation target and or cleanliness of the ablation loading subsystem 620. Moreover, a mechanical seal may be baked out at the higher temperatures needed for effective degassing and getter activations required for room temperature XHV.

The present disclosure comprises a specialized geometry of the frame 608 brazed hermetically using a tee joint to the ceramic chip carrier 604. In some aspects, the frame 608 may be or include a titanium material. The ceramic chip carrier 604 has electronic connections 618 such as LGA or PGA accessible on the back side 614, which allows the ceramic chip carrier 604 to function as an electrical feedthrough to UHV or XHV. The frame 608 is designed so that mechanical seals may be made between the frame 608 and other vacuum components (e.g., such as the vacuum housing 408 and the ceramic chip carrier 604) to form a vacuum enclosure. Moreover, the frame 608 contains a location to which an ablation loading subsystem 420 may be added, to allow for backside ablation loading of the ion trap 436. Finally, the assembly formed by the frame 608 and the ceramic chip carrier 604 is designed to withstand high temperature bakeouts necessary for XHV conditions and for the activation of getters 450 and gettering surfaces.

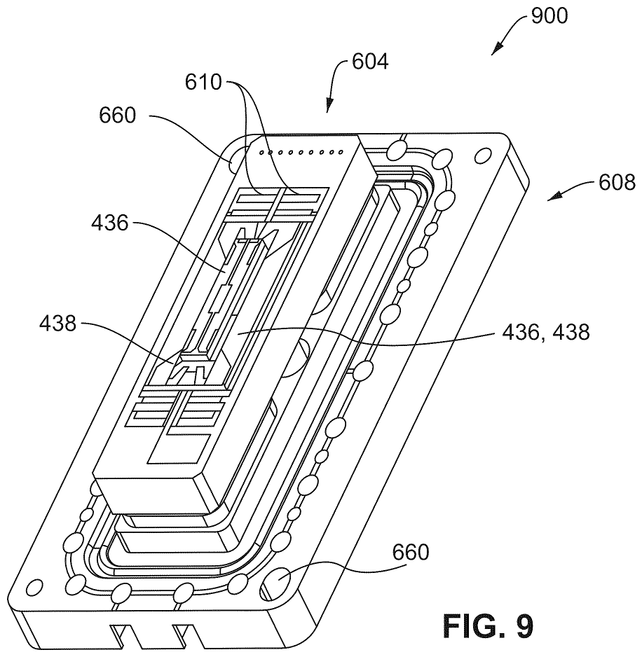

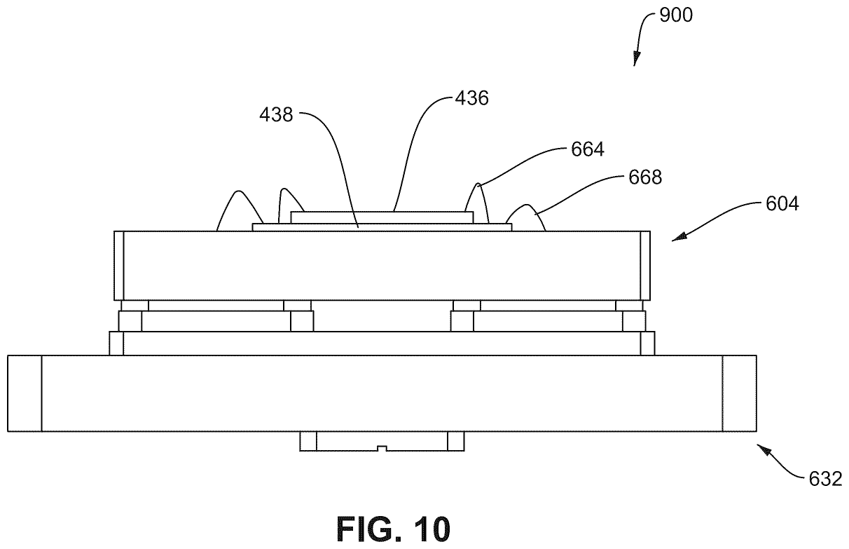

As shown in FIGS. 9-10, the ion trap 436 can be coupled to the ceramic chip carrier 604 to form an ion trap subsystem 900. The ion trap subsystem 900 can then be combined with the vacuum housing 408 and the ablation loading subsystem 620 to form the compact ion trap package.

In some aspects, the ion trap 436 may be coupled to the ceramic chip carrier 604. In some aspects, the ion trap 436 may be coupled to the interposer 438, which is coupled to the ceramic chip carrier 604. The coupling between the ion trap 436, the interposer 438, and/or the ceramic chip carrier 604 uses a low outgassing material that is compatible with subsequent UHV vacuum processing steps (e.g., high temperature bakeout). In some aspects, the ion trap 436 may be coupled to the ceramic chip carrier 604 and/or the interposer 438 via soldering, and the interposer 438 (if used) may be coupled to the ceramic chip carrier 604 via soldering. In such aspects, the solder material should be a low outgassing solder material that is compatible with subsequent UHV vacuum processing steps (e.g., high temperature bakeout). In some aspects, the solder includes eutectic solders, such as Gold-tin solder. Eutectic solders are generally low outgassing and can withstand even higher temperatures after the first reflow. Gold-tin composition, and gold thicknesses can be chosen to reduce the probability of brittle joints or dissolving of gold into the solder. In some aspects, the solder material does not include lead, which has a high vapor pressure, or indium, which has a low melting point. When coupling the ion trap 436, the interposer 438, and/or the ceramic chip carrier 604, care should be taken to prevent formation of voids, which can act as virtual leaks in vacuum. Controlled processes (i.e. pressure, or vacuum reflow), as well as weighting can help reduce voids.

In aspects that include the interposer 438, the ion trap 436 may be coupled to the interposer by one or more first wirebonds 664. The interposer 438 may be coupled to the ceramic chip carrier 604 via one or more second wirebonds 668. In aspects that do not include the interposer 438, the ion trap 436 may be coupled to the ceramic chip carrier 604 by wirebonds.

The ion trap 436 may have a well-defined location with respect to the titanium frame, so that the ion trap 436 location can be known with respect to any device containing the ion trap subsystem 800. For example, in some aspects, the planar body 624 of the frame 608 may include one or more alignment features 660. In some aspects, the alignment features 660 may include carefully toleranced holes and slots configured to receive dowel pins.

In the design of jigging for the reflow, the ion trap 436 should be toleranced with respect to the titanium frame, so that the location of the ion trap 436 is well defined with respect to components that may be outside of the vacuum system that contains the ion trap subsystem 800.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system including:
a vacuum housing;
a ceramic chip carrier; and
a frame coupled to the vacuum housing via a first hermetic seal and coupled to the ceramic chip carrier via a second hermetic seal, wherein the first hermetic seal and the second hermetic seal are configured to withstand high temperature bakeout.

2. The QIP system of claim 1, wherein the frame includes a planar body and one or more protruding portions, and wherein the vacuum housing is coupled to the planar body and the ceramic chip carrier is coupled to the one or more protruding portions such that the ceramic chip carrier is vertically spaced from the vacuum housing.

3. The QIP system of claim 1, wherein the first hermetic seal is a mechanical compression seal.

4. The QIP system of claim 1, wherein the second hermetic seal is a braze between the ceramic chip carrier and the frame.

5. The QIP system of claim 4, wherein the ceramic chip carrier is directly brazed to the frame.

6. The QIP system of claim 1, wherein the ceramic chip carrier is not directly coupled to the vacuum housing.

7. The QIP system of claim 1, wherein the frame includes titanium and the ceramic chip carrier includes a high temperature co-fired ceramic material.

8. The QIP system of claim 1, wherein a coefficient of thermal expansion (CTE) of the frame is within 2 ppm/K of a CTE of the ceramic chip carrier.

9. The QIP system of claim 1, wherein the ceramic chip carrier includes a first face and a second face opposite the first face, and wherein first face is within a vacuum chamber defined between the vacuum housing, the frame, and the ceramic chip carrier, and wherein an ion trap is coupled to the first face.

10. The QIP system of claim 9, wherein at least a portion of second face is exposed to atmospheric conditions, and wherein a plurality of electrical connections extend between the first face and the second face such that first ends of the electrical connections are positioned within the vacuum chamber and that second ends of the electrical connections are exposed to atmospheric conditions.

11. The QIP system of claim 9, wherein the second face is within a second vacuum chamber defined between a second vacuum housing and the ceramic chip carrier.

12. The QIP system of claim 10, wherein an ablation loading subsystem is coupled to the second face such that the ion trap can be loaded from the second face.

13. A quantum information processing (QIP) system including:
a vacuum housing including a titanium material;
one or more non-evaporable getters coupled to the housing;
a ceramic chip carrier; and
a frame coupled to the vacuum housing via a first hermetic seal and coupled to the ceramic chip carrier via a second hermetic seal to define a vacuum chamber therebetween,
wherein the vacuum housing, the frame, and the non-evaporable getters are configured to maintain the vacuum chamber at ultra high vacuum (UHV) or extreme high vacuum (XHV) conditions at non-cryogenic temperatures.

14. The QIP system of claim 13, wherein the non-cryogenic temperatures comprise room temperature conditions.

15. The QIP system of claim 13, wherein the non-cryogenic temperatures comprise liquid nitrogen-cooled temperatures.

16. The QIP system of claim 13, wherein the first hermetic seal is a mechanical compression seal.

17. The QIP system of claim 13, wherein the second hermetic seal is a braze directly between the ceramic chip carrier and the frame.
